(19) United States
(12) Patent Application Publication
(10) Pub. No.: US 2017/0315778 A1
(43) Pub. Date: Nov. 2, 2017

(54) SEMICONDUCTOR DEVICE

(71) Applicant: Renesas Electronics Corporation, Tokyo (JP)

(72) Inventor: Keiichiro SANO, Tokyo (JP)

(73) Assignee: Renesas Electronics Corporation, Tokyo (JP)

(21) Appl. No.: 15/471,159

(22) Filed: Mar. 28, 2017

(30) Foreign Application Priority Data
Apr. 27, 2016 (JP) 2016-088679

(51) Int. Cl. G06F 7/485; G06F 7/487; G06F 13/16; G06F 13/40

(52) U.S. Cl. CPC G06F 7/485; G06F 13/4068; G06F 7/487; G06F 13/1668

(57) ABSTRACT

When the conversion arithmetic of the numerical type of floating-point data and integer data is performed by software, the load of the CPU becomes heavy. A semiconductor device includes a memory, a bus coupled to the memory, a bus master coupled to the bus, and a conversion arithmetic circuit coupled to the bus. The conversion arithmetic circuit includes a floating-point data adder-subtracter, an integer data adder-subtracter, and a shift operator. The semiconductor device converts the floating-point data to the integer data or converts the integer data to the floating-point data, without employing a multiplier and a divider of the floating-point data.

### CROSS-REFERENCE TO RELATED APPLICATIONS

The disclosure of Japanese Patent Application No. 2016-088679 filed on Apr. 27, 2016 including the specification, drawings, and abstract is incorporated herein by reference in its entirety.

### BACKGROUND

The present disclosure relates to a semiconductor device and is applicable to a semiconductor device containing floating-point arithmetic function.

Some types of electronic control devices, which are employed for control of a vehicle engine, use floating-point data instead of integer data (fixed-point data) for execution of various kinds of arithmetic (for example, U.S. Patent Application Publication No. 2004/186866). Use of the floating-point data enables a more highly precise arithmetic to be attained, than is possible with the integer data.

(Patent Literature 1) U.S. Patent Application Publication No. 2004/186866

### SUMMARY

When the conversion arithmetic of the numerical type of floating-point data and integer data is performed by software (execution of a program by a central processing unit (CPU)), the load to the CPU will become heavy. On the other hand, when an exclusive-use floating-point processor is employed, a circuit scale will become large. The other issues and new features of the present invention will become clear from the description of the present specification and the accompanying drawings.

The following explains briefly the outline of a typical embodiment of the present disclosure. That is, a conversion arithmetic circuit mounted in a semiconductor device includes an adder-subtracter of floating-point data, an adder-subtracter of integer data, and a shift operator, and converts the floating-point data to the integer data or converts the integer data to the floating-point data, without employing a multiplier and a divider of the floating-point data.

According to the semiconductor device, the load of the CPU can be reduced.

### BRIEF DESCRIPTION OF THE DRAWINGS

FIG. 1 is a drawing illustrating a format of floating-point data in a single precision storage format;

FIG. 2 is a drawing illustrating the concept of conversion arithmetic according to a comparative example;

FIG. 3 is a drawing for explaining a concrete example of a compression operation;

FIG. 4 is a drawing for explaining another concrete example of the compression operation;

FIG. 5 is a drawing for explaining a concrete example of a decompression operation;

FIG. 6 is a drawing for explaining another concrete example of the decompression operation;

FIG. 7 is a block diagram illustrating a configuration of a micro controller not provided with an exclusive-use floating-point processor;

FIG. 8 is a block diagram illustrating a configuration of a micro controller provided with an exclusive-use floating-point processor;

FIG. 9 is a drawing for explaining algorithm of a compression operation according to an embodiment;

FIG. 10 is a flow chart for explaining the compression operation according to the embodiment;

FIG. 11 is a drawing for explaining algorithm of a decompression operation according to the embodiment;

FIG. 12 is a flow chart for explaining the decompression operation according to the embodiment;

FIG. 13 is a drawing for explaining algorithm of a compression operation according to a modified embodiment 1;

FIG. 14 is a drawing for explaining algorithm of a decompression operation according to the modified embodiment 1;

FIG. 15 is a drawing for explaining algorithm of a compression operation according to a modified embodiment 2;

FIG. 16 is a block diagram illustrating a configuration of a system according to an implementation example 1;

FIG. 17 is a block diagram illustrating a configuration of a micro controller according to an implementation example 2;

FIG. 18 is a block diagram illustrating a configuration of a conversion arithmetic circuit according to the implementation example 2;

FIG. 19 is a drawing illustrating a configuration of a descriptor;

FIG. 20 is a flow chart of an operation;

FIG. 21 is a block diagram illustrating a configuration of a micro controller according to an implementation example 3;

FIG. 22 is a block diagram illustrating a configuration of a conversion arithmetic circuit according to the implementation example 3;

FIG. 23 is a drawing illustrating a configuration of a descriptor; and

FIG. 24 is a flow chart of an operation.

### DETAILED DESCRIPTION

Hereinafter, a comparative example, an embodiment, and an implementation example are explained with reference to drawings. In the following explanation, the same symbol or reference numeral is attached to the same element and the repeated explanation thereof may be omitted.

Depending on an application, many of variables have floating-point data. However, in contrast to values that can be expressed by the floating-point data, the value that can actually be taken is restrictive. For example, a temperature sensor employs floating-point data for expressing an outside air temperature, and the range of the value that can actually be taken is from −273° C. to 1,200° C. For handling this as it is in a communication circuit (such as CAN (Controller Area Network), I²C (Inter-Integrated Circuit), SPI (Serial Peripheral Interface), and Ethernet), the communication latency is poor. Therefore, it is examined to convert the floating-point data (float) to an unsigned integer data (uint) to compress the data and to improve the communication latency, at the cost of decrease of the accuracy of the signal.

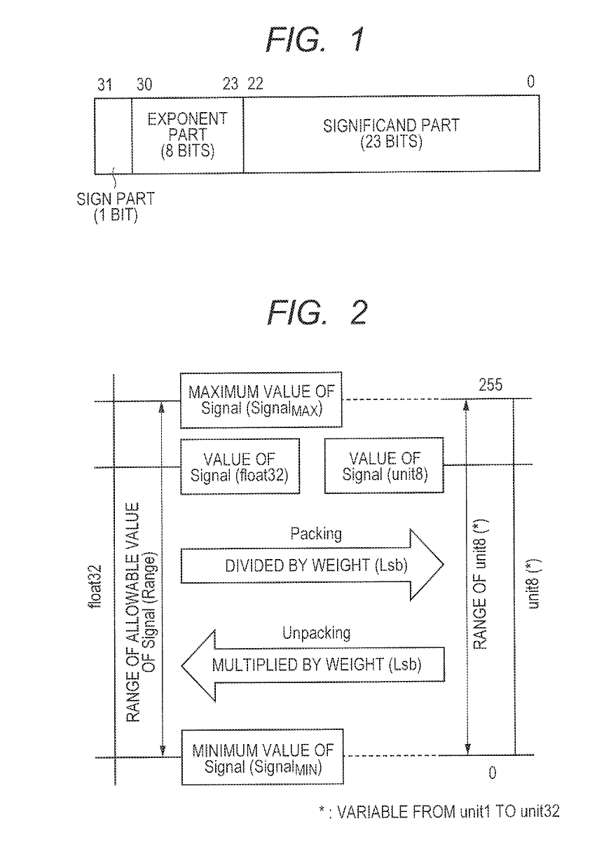

First, the format of the floating-point data is explained with reference to FIG. 1. FIG. 1 illustrates the format of the floating-point data represented by a single precision storage format in conformity with the IEEE 754 standard. The data represented by the single precision storage format is comprised of 4 bytes, including a 1-bit sign part (S), an 8-bit exponent part (E), and a 23-bit mantissa (or significand) part (M). The value expressed by this representation is

(−1)^{S}×2^{(E-127)}×(1+M).

Here, M is a number of the decimal places. By employing this floating-point data, arithmetic is performed in the accuracy of “½²³≈0.0000001”, that is, the accuracy of 7 decimal places, since the significand part is comprised of 23 bits.

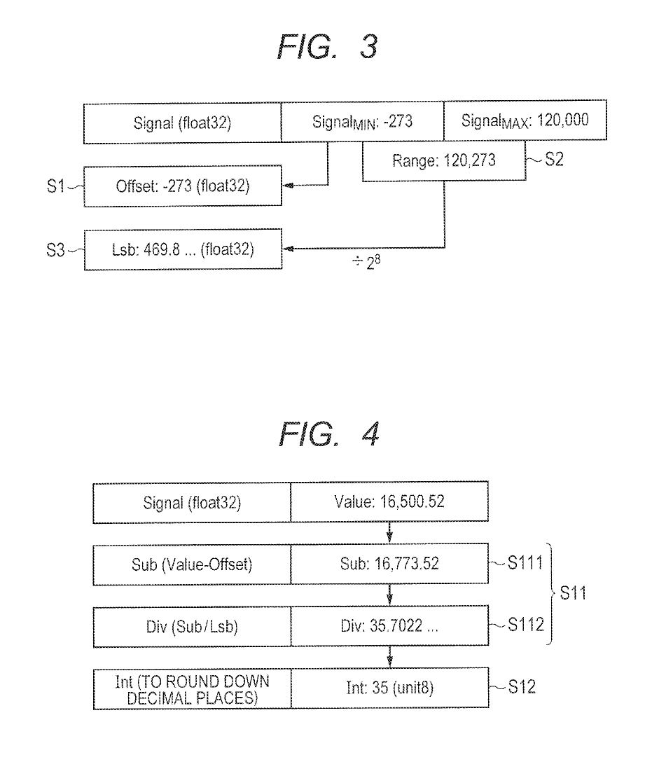

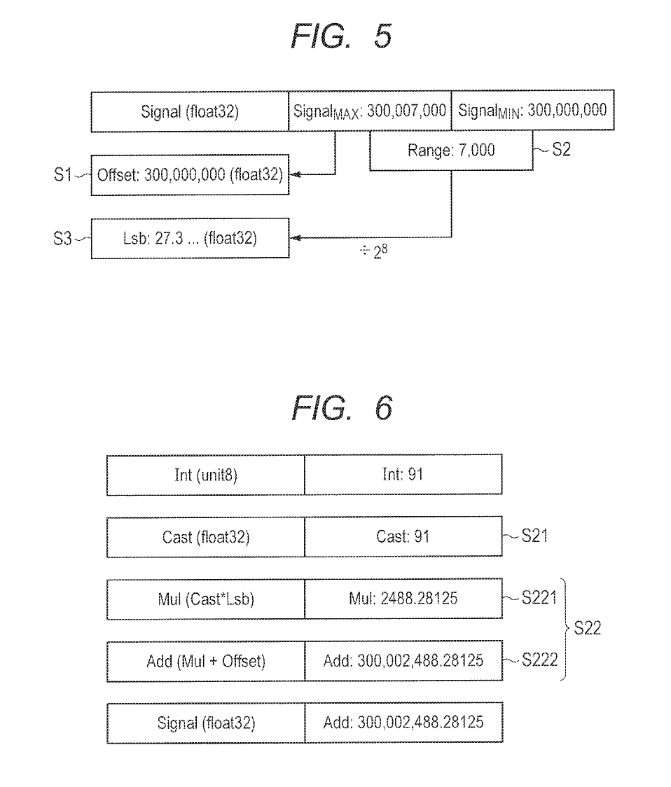

Next, the conversion arithmetic of the numerical type (hereinafter “conversion arithmetic”) between floating-point data and unsigned integer data, which the inventors of the present invention have examined (hereinafter called a “comparative example”), is explained with reference to FIG. 2 to FIG. 9. The conversion from floating-point data to unsigned integer data is called “compression”, and the arithmetic conversion from unsigned integer data to floating-point data is called “decompression.” FIG. 2 illustrates the concept of conversion arithmetic according to the comparative example. FIG. 3 and FIG. 4 explain a concrete example of the compression operation. FIG. 5 and FIG. 6 explain a concrete example of the decompression operation.

<The Concept of Conversion Arithmetic>As illustrated in FIG. 1, the floating-point data has a 32-bit length. This floating-point data is defined as float32. Conversion arithmetic is performed between float32 and unsigned integer data of an n-bit length (uintn). FIG. 2 illustrates the case of n=8. However, n is variable in the range of n=1 to n=32. A small n is preferable from the viewpoint of compressing data and a large n is preferable from the viewpoint of accuracy.

The maximum value of the floating-point data (float32) (the maximum value of Signal) is defined as Signal_{MAX}, and the minimum value of the floating-point data (the minimum value of Signal) is defined as Signal_{MIN}. The maximum value of uintn is 2ⁿ−1 and the minimum value is 0.

<Initial Definition>

First, the minimum value of Signal is defined as Offset.

Offset=Signal_{MIN}

Next, the range of an allowable value of Signal is defined as Range.

Range=Signal_{MAX}−Signal_{MIN}

Finally, Range divided by 2ⁿ is defined as Lsb.

Lsb=Range/2ⁿ

For example, when the weight is set as 0 to 255, then, n=8. Hereinafter, the case of n=8 is explained. The initial definition is common to the compression operation (when converting Signal of float32 into U1 of unit8) and the decompression operation (when converting U1 of unit8 into Signal of float32).

When converting Signal of float32 to U1 of unit8, first, Signal is subtracted by Offset and divided by Lsb, and the result is defined as F4.

F4=(Signal−Offset)/Lsb

F4 always fits to a value from 0 to 255. Next, F4 of the floating-point number is converted into U1 of an integer.

U1=(unit8) F4

When converting U1 of unit8 into Signal of float32, U1 of an integer is first converted into F4 of a floating-point number.

F4=(float) U1

Next, Signal is obtained by multiplying F4 by Lsb and adding Offset.

Signal=(F4×Lsb)+Offset

<A concrete example of float32→unit8>

(Preparation of Offset and Lsb)

As illustrated in FIG. 3, as for Signal (float32), when the minimum value is “−273 (d) ” and the maximum value is “120,000 (d)”, a data table is prepared by setting “the minimum value” to “Offset” at Step S1, and setting “the absolute value (Range) of the allowable range divided by 256” to “Lsb” at Step S2 and Step S3. Here, Offset=Signal_{MIN}=−273(d), Range=Signal_{MAX}−Signal_{MIN}=120,273(d), and Lsb=Range/256=469.8 . . . . In the above description, (d) denotes that the precedent number is a decimal digit.

(Compression)

As illustrated in FIG. 4, when the value (Value) of the floating-point data (Signal (float32)) is “16,500.52”, Lsb and Offset are acquired from the data table, Offset is subtracted from Value (Sub(Value−Offset)) at Step S111, and Sub=16,773.52 is obtained. At Step S112, Sub is divided by Lsb (Div (Sub/Lsb)), to obtain Div=35.7022. At Step S112, the decimal places of Div is rounded down to convert into an integer (Int(Div)), and Int=35 (unit8) is obtained.

<A Concrete Example of Unit8→Float32>

(Preparation of Offset and Lsb)

As illustrated in FIG. 5, as for Signal (float32), when the minimum value is “300,000,000 (d)” and the maximum value “300,007,000 (d)”, a data table is prepared by setting “the minimum value” to “Offset” at Step S1, and setting “the absolute value (Range) of the allowable range divided by 256” to “Lsb” at Step S2 and Step S3. Here, Offset=Signal_{MIN}=300,000,000 (d), Range=Signal_{MAX}−Signal_{MIN}=7,000 (d), and Lsb=Range/256=27.3.

(Decompression)

As illustrated in FIG. 6, when the value (Int) of integer data (Int (unit8)) is assumed to be “91”, the value is converted into a single precision floating point (Cast(float32)), to obtain Cast=91, at Step S21. At Step S221, Lsb is multiplied to Cast (Mul (Cast×Lsb)) to obtain Mul=2488.28125. At Step S222, Offset is added to Mul (Add (Mul+Offset)) to obtain Add=300,002,488.28125. Accordingly, it is possible to obtain the single precision floating-point data (Signal(float32)).

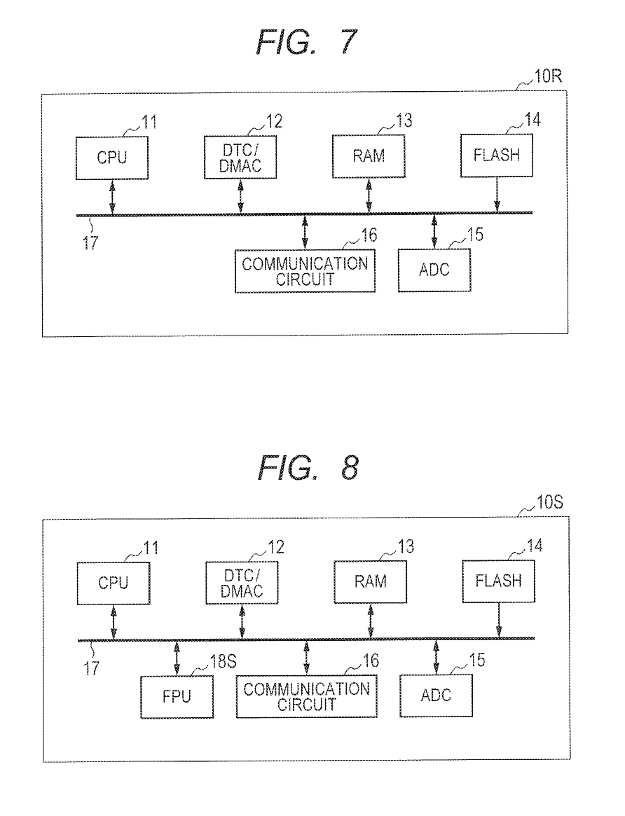

Next, the configuration of a micro controller that performs conversion arithmetic is explained with reference to FIG. 7 and FIG. 8. FIG. 7 is a block diagram illustrating a configuration of a micro controller not provided with an exclusive-use floating-point processor. FIG. 8 is a block diagram illustrating a configuration of a micro controller provided with an exclusive-use floating-point processor.

The micro controller 10R illustrated in FIG. 7 includes a central processing unit (CPU) 11, a data transfer controller/direct memory access controller (DTC/DMAC) 12, a random access memory (RAM) 13, a flash memory (FLASH) 14, an analog-to-digital conversion circuit (ADC) 15, a communication circuit 16, and a bus 17. The program and the data table employed in the conversion arithmetic are stored in the FLASH 14. In the conversion arithmetic, the CPU 11 reads and executes the program stored in the FLASH 14, and the data of the conversion arithmetic is stored in the RAM 13.

The micro controller 10S illustrated in FIG. 8 includes a central processing unit (CPU) 11, a data transfer controller/direct memory access controller (DTC/DMAC) 12, a random access memory (RAM) 13, a flash memory (FLASH) 14, an analog-to-digital conversion circuit (ADC) 15, a communication circuit 16, a bus 17, and a floating-point processor (FPU) 18S. The program and the data table employed in the conversion arithmetic are stored in the FLASH 14. The FPU 18S reads and executes the program stored in the FLASH 14 (or the CPU 11 reads the program stored in the FLASH 14 and makes the FPU 18S execute the program), and the data of the conversion arithmetic is stored in the RAM 13.

As described above, in the conversion arithmetic according to the comparative example, division and multiplication of floating-point data are necessary. When the division and multiplication of the floating-point data are performed by the CPU 11 of the micro controller 10R, the load to the CPU 11 will become heavy. On the other hand, when the division and multiplication of the floating-point data are performed by the FPU 18S (with a divider and a multiplier) of the micro controller 10S, the circuit scale will become large.

### Embodiment

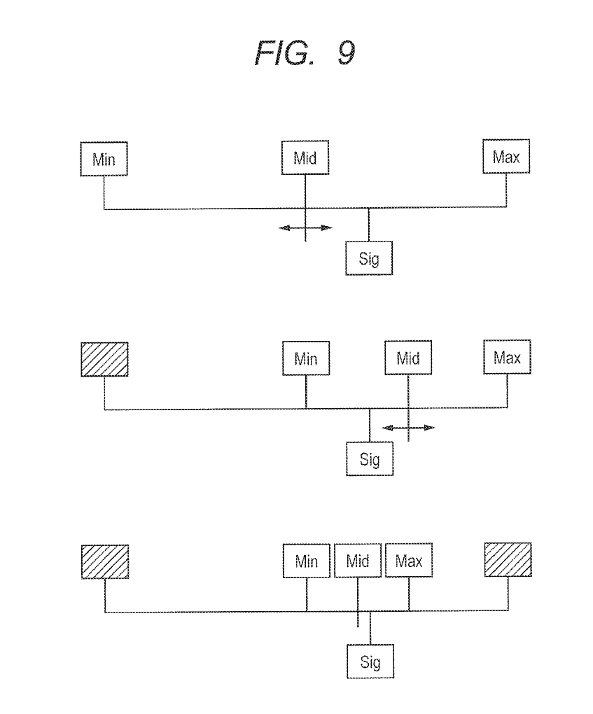

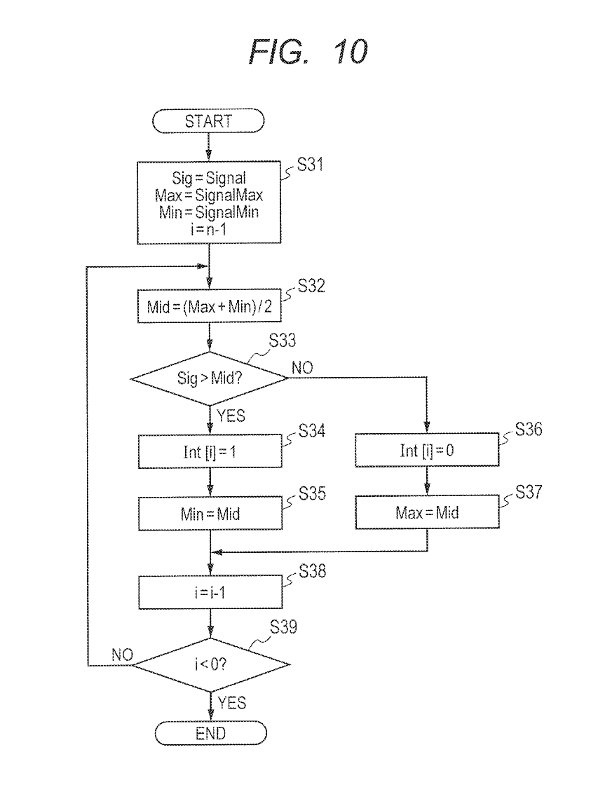

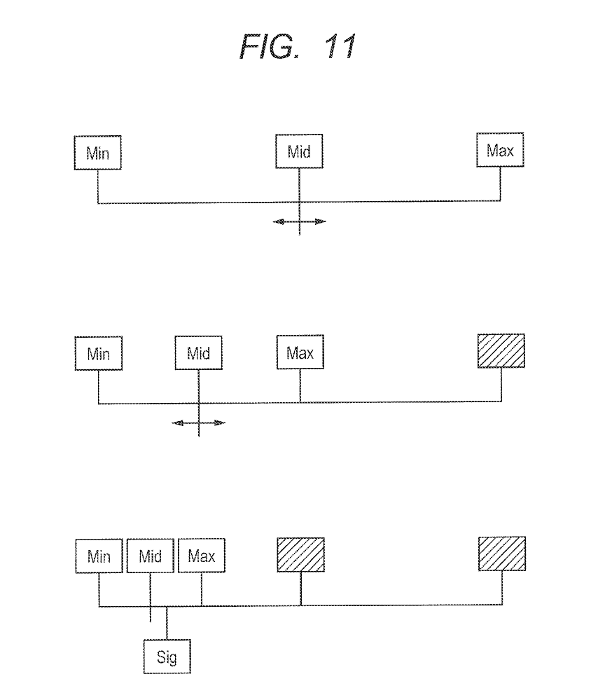

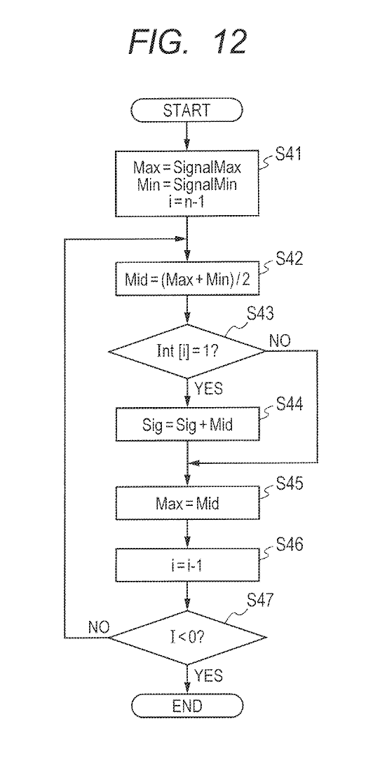

The conversion arithmetic according to an embodiment is explained with reference to FIG. 9 to FIG. 12. FIG. 9 explains algorithm of a compression operation according to the embodiment. FIG. 10 is a flow chart for explaining the compression operation. FIG. 11 explains algorithm of a decompression operation. FIG. 12 is a flow chart for explaining the decompression operation.

(A Compression Operation)

When converting a floating-point number into an integer, the bisection method that iterates comparison with a middle value is employed.

First, a middle value of the maximum value (Signal_{MAX}) of Signal and the minimum value (Signal_{MIN}) of Signal is calculated.

Step S31: Set Signal of the conversion target data to Sig, set Signal_{MAX} to Max, and set Signal_{MIN} to Min. Set n−1 indicative of an integral bit position to i. “i” also denotes the number of iteration.

Step S32: Calculate the middle value of Max and Min and set the middle value to Mid. The middle value can be obtained by the subtraction of the floating-point data and the subtraction of the exponent part.

Next, when Signal is greater than the middle value, set “1” to the bit of Int, and when Signal is smaller than the middle value, set “0” to the bit of Int. FIG. 9 illustrates the first iteration in which Signal is greater than the middle value, and the second iteration in which Signal is smaller than the middle value.

Step S33: Determine whether Sig is greater than Mid. When the determination is YES, the flow moves to Step S34, and, when the determination is NO, the flow moves to Step S36.

Step S34: Set “1” to the (n−1)th bit of Int. Set “1” to the (n−2)th bit at the second iteration. Similarly hereinafter, and set “1” to the 0th bit at the nth iteration.

Step S35: Set the contents of Mid to Min.

Step S36: Set “0” to the (n−1)th bit of Int. Set “0” to the (n−2)th bit at the second iteration. Similarly hereinafter, and set “0” to the 0th bit at the nth iteration.

Step S37: Set the contents of Mid to Max.

Step S38: Decrement the content of i by one.

Next, the processing is iterated n times and float is converted into uintn.

Step S39: Determine whether a prescribed number of times (n times) has been iterated (i<0). When the determination is YES, the flow terminates. When the determination is NO, the flow moves to Step S32.

(A Decompression Operation)

When converting an integer into a floating-point number, the arithmetic method that iterates addition of a middle value is employed.

First, a middle value of the maximum value of Signal (Signal_{MAX}) and the minimum value of Signal (Signal_{MIN}) is calculated.

Step S41: Set Signal_{MAX} to Max and set Signal_{MIN} to Min. Set n−1 indicative of an integral bit position to i. “i” also denotes the number of iteration.

Step S42: Calculate the middle value of Max and Min and set the middle value to Mid. The middle value can be obtained by the subtraction of the floating-point data and the subtraction of the exponent part.

Next, when the bit of Int is “1”, add the value of Mid to Sig, and when the bit of Int is “0”, do not add the value of Mid to Sig.

Step S43: Determine whether the (n−1) th bit of Int is “1.” When the determination is YES, the flow moves to Step S44. When the determination is NO, the flow moves to Step S45.

Step S44: Add the value of Mid to Sig.

Step S45: Set the contents of Mid into Max.

Step S46: Decrement the content of i by one.

Next, the processing is iterated n times and uintn is converted into float.

Step S47: Determine whether a prescribed number of times (n times) has been iterated (i<0). When the determination is YES, the flow terminates. When the determination is NO, the flow moves to Step S42.

In the conversion arithmetic according to the embodiment, it is not necessary to perform the division and multiplication of the floating-point data, which are necessary in the comparative example. Accordingly, when the conversion arithmetic is performed by the CPU 11 of the micro controller 10R, it becomes possible to reduce the load of the CPU 11. By employing the conversion arithmetic circuit that does not include a divider and a multiplier, instead of the FPU 18S of the micro controller 10S, it is possible to suppress the increase of the circuit scale.

### Modified Embodiment 1

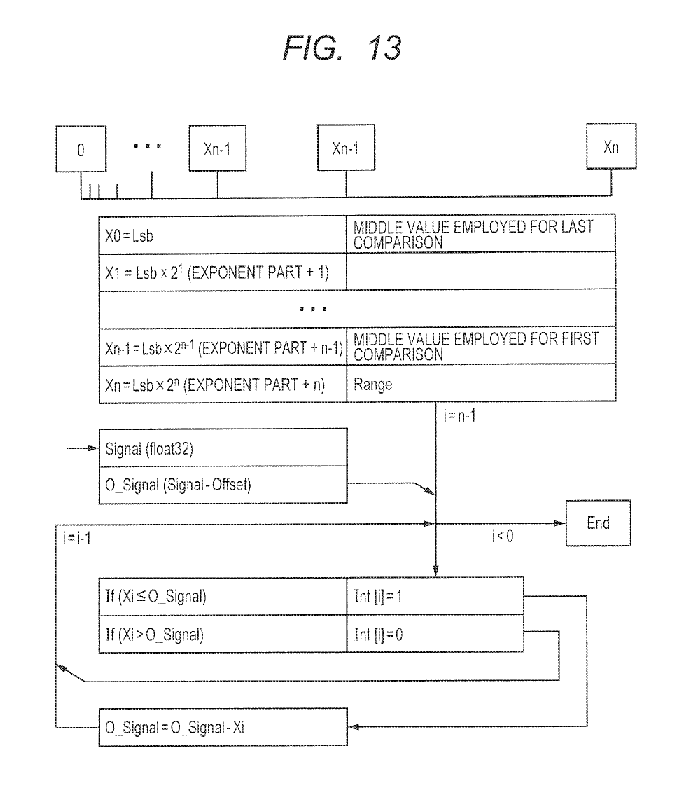

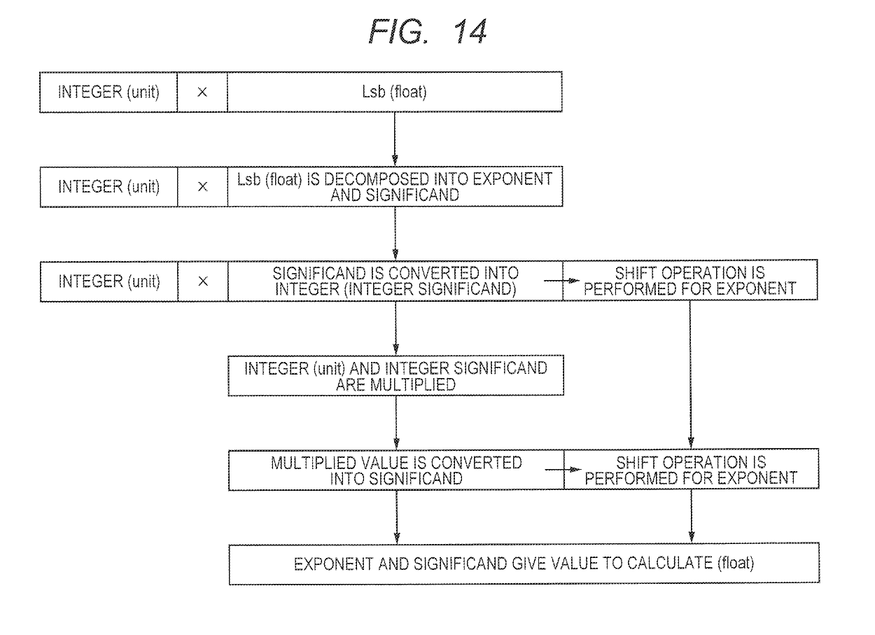

Next, the conversion arithmetic according to a modified embodiment 1 is explained with reference to FIG. 13 and FIG. 14. FIG. 13 explains algorithm of a compression operation. FIG. 14 explains algorithm of a decompression operation.

The conversion arithmetic according to the modified embodiment 1 is the bisection method that employs Offset and Lsb, which are same as in the initial definition of the embodiment described above. Offset and Lsb are defined as follows.

Offset=Signal_{MIN}

Range=Signal_{MAX}−Signal_{MIN}=Signal_{MAX}−Offset

Lsb=Range/2ⁿ

Here, the maximum value of the floating-point data (float32) (the maximum value of Signal) is defined as Signal_{MAX}, and the minimum value of the floating-point data (the minimum value of Signal) is defined as Signal_{MIN}.

(A Compression Operation)

It is defined as follows with Xn as Range:

Xn−1=Xn/2=Xn×2⁻¹,

Xn−2=Xn−1/2=Xn/4=Xn×2⁻²,

. . . ,

X1=Xn×2⁻⁽ⁿ⁻¹⁾,

and

X0=Xn×2⁻ⁿ.

Xn−1 is a middle value between Xn and 0, and Xn−2 is a middle value between Xn−1 and 0. Here, Xn=Range=Lsb×2ⁿ (the exponent part of Xn is the exponent part of Lsb+n), therefore,

Xn−1=Lsb×2ⁿ⁻¹ (the exponent part of Xn−1 is the exponent part of Lsb+n−1),

Xn−2=Lsb×2^{n 2} (the exponent part of Xn−2 is the exponent part of Lsb+n−2),

. . . ,

X1=Lsb×2¹ (the exponent part of X1 is the exponent part of Lsb+1), and

X0=Lsb×2⁰=Lsb.

The middle value employed for the first comparison is Xn−1=Lsb×2ⁿ⁻¹, and the middle value employed for the last comparison is X0=Lsb.

Signal as the conversion target is also employed after subtracting Offset. This is defined as O_Signal(=Signal−Offset).

The case of i=n−1: Compare Xn−1 with O₋Signal. When Xn−1 is not greater than O_Signal, set “1” to the (n−1)th bit of Int, and define O_Signal from which Xn−1 is subtracted as O_Signal. When Xn−1 is greater than O_Signal, set “0” to the (n−1)th bit of Int.

The case of i=n−2: Compare Xn−2 with O_Signal. When Xn−2 is not greater than O_Signal, set “1” to the (n−2)th bit of Int, and define O_Signal from which Xn−2 is subtracted as O_Signal. When Xn−2 is greater than O_Signal, set “0” to the (n−2)th bit of Int.

Hereinafter, similar arithmetic is performed by decrementing i by one.

The case of i=1: Compare X1 with O_Signal. When X1 is not greater than O_Signal, set “1” to the 1st bit of Int, and define O_Signal from which X1 is subtracted as O_Signal. When X1 is greater than O_Signal, set “0” to the 1st bit of Int.

The case of i=0: Compare X0 with O_Signal. When X0 is not greater than O_Signal, set “1” to the 0th bit of Int, and define O_Signal from which X0 is subtracted as O_Signal. When X0 is greater than O_Signal, set “0” to the 0th bit of Int.

When i becomes a negative number, the arithmetic is terminated. The converted integer is stored in Int. Accordingly, the arithmetic to calculate the middle value becomes simpler than in the embodiment.

(A Decompression Operation)

By multiplying Lsb (float) to an integer (unit), it is possible to convert the integer data (unit) into the floating-point data (float). An example of the conversion from the integer (unit8) to the floating point (float32) without employing multiplication of the floating point is explained in the following.

First, Lsb (float) is decomposed into an exponent and a significand.

signal(float32)=unit8×Lsb(float32)

signal(float32)=unit8×sign×2^{(exponent-127)}×(1.significand)

The floating-point data of the single precision storage format in conformity with the IEEE 754 standard is

(−1)^{sign}×2^{(exponent-127)}×(1.significand).

Next, a significand is converted into an integer (integer significand).

Sign×signal(float32)=unit8×integer significand(24 bits)×2⁻²³×2^{(exponent-127)}.

This can be performed by the shift operation of the exponent.

Next, the integer (unit) and the integer significand are multiplied.

Sign×signal(float32)=unit32×2^{(exponent-23-127)}

This arithmetic is performed by integral multiplication.

Next, the multiplied value is converted into the significand.

Sign×signal(float32)=unit24×2^{(shifted number)}×2^{(exponent-23-127)}

Here, unit24 is the number shifted to the highest order of 1. This arithmetic can be performed by the shift operation of the exponent.

Finally, the value (float) to be calculated is obtained with the significand and the exponent.

sign×signal(float32)=(1.significand)×2^{(exponent-127)}

signal(float32)=sign×2^{(exponent-127)}×(1.significand)

Here, the significand is the lower-order 23 bits of unit24. The exponent is given by (the first exponent—23—the shifted number). In the conversion arithmetic according to the modified embodiment 1, as is the case with the embodiment, it is not necessary to perform the division and multiplication of the floating-point data, which are necessary in the comparative example.

<Modified Embodiment 2>

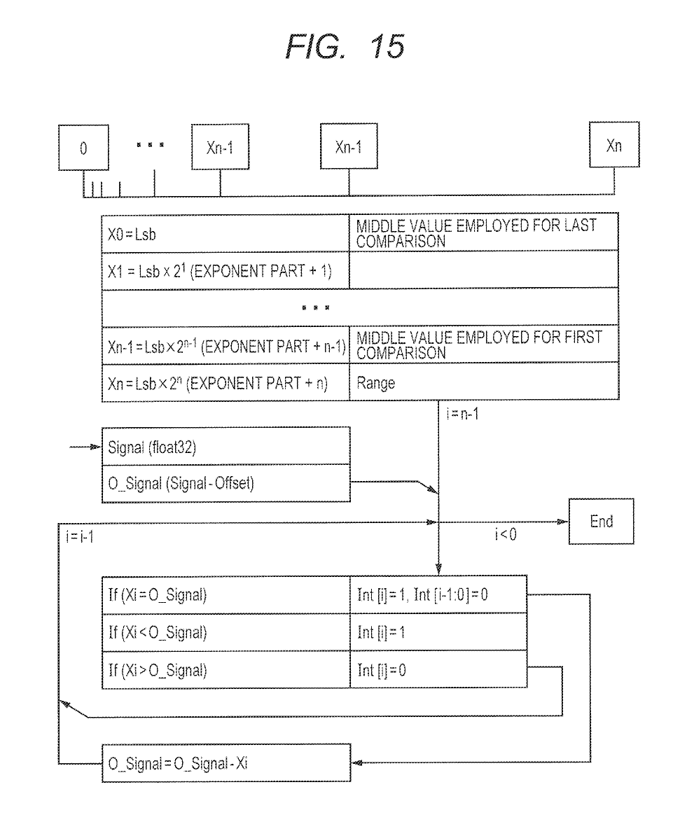

Next, the conversion arithmetic according to the modified embodiment 2 is explained with reference to FIG. 15. FIG. 15 explains the algorithm of a compression operation.

The conversion arithmetic according to the modified embodiment 2 is the same as the algorithm of the compression operation illustrated in FIG. 13, except that the arithmetic terminates when Xi (i=0 to n−1) coincides with O_Signal.

The case of i=n−1: Compare Xn−1 with O_Signal. When Xn−1 is equal to O_Signal, set “1” to the (n−1)th bit of Int, set “0” to all of the (n−2) th bit and the lower bits, and terminate the arithmetic. When Xn−1 is smaller than O_Signal, set “1” to the (n−1) th bit of Int, and define O_Signal from which Xn−1 is subtracted as O_Signal. When Xn−1 is greater than O_Signal, set “0” to the (n−1)th bit of Int.

The case of i=n−2: Compare Xn−2 with O_Signal. When Xn−2 is equal to O_Signal, set “1” to the (n−2)th bit of Int, set “0” to all of the (n−3)th bit and the lower bits, and terminate the arithmetic. When Xn−2 is smaller than O_Signal, set “1” to the (n−2) th bit of Int, and define O_Signal from which Xn−2 is subtracted as O_Signal. When Xn−2 is greater than O_Signal, set “0” to the (n−2)th bit of Int.

Hereinafter, similar arithmetic is performed by decrementing i by one.

The case of i=1: Compare X1 with O_Signal. When X1 is equal to O_Signal, set “1” to the 1st bit of Int, set “0” to the 0th bit, and terminate the arithmetic. When X1 is smaller than O_Signal, set “1” to the 1st bit of Int, and define O_Signal from which X1 is subtracted as O_Signal. When X1 is greater than O_Signal, set “0” to the 1st bit of Int.

The case of i=0: Compare X0 with O_Signal. When X0 is equal to O_Signal, set “1” to the 1st bit of Int and terminate the arithmetic. When X0 is smaller than O_Signal, set “1” to the 0th bit of Int, and define O_Signal from which X0 is subtracted as O_Signal. When X0 is greater than O_Signal, set “0” to the 0th bit of Int.

When i becomes a negative number, the arithmetic is terminated. The converted integer is stored in Int. In the conversion arithmetic according to the modified embodiment 2, as is the case with the embodiment, it is not necessary to perform the division and multiplication of the floating-point data, which are necessary in the comparative example.

### Implementation Example 1

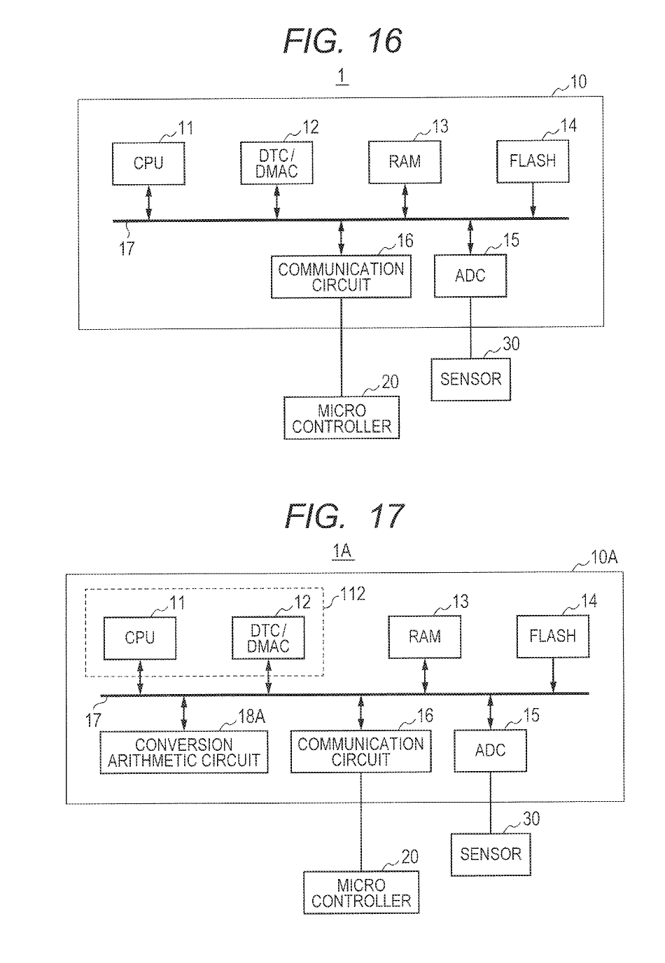

A system according to an implementation example 1 is explained with reference to FIG. 16. FIG. 16 is a block diagram illustrating the configuration of the system according to the implementation example 1.

The system 1 according to the implementation example 1 includes a micro controller 10, a sensor 30, and a micro controller 20. The micro controller 10 includes a central processing unit (CPU) 11, a data transfer controller/direct memory access controller (DTC/DMAC) 12, a random access memory (RAM) 13, a flash memory (FLASH) 14, an analog-to-digital conversion circuit (ADC) 15, a communication circuit 16, and a bus 17. The micro controller 10 is a semiconductor device formed over one semiconductor chip (a semiconductor substrate). The program and the data table of the conversion arithmetic according to the embodiment, the modified embodiment 1, or the modified embodiment 2 are stored in the FLASH 14. The CPU 11 reads the program stored in the FLASH 14 to execute the conversion arithmetic, and the data of the conversion arithmetic is stored in the RAM 13. A device that includes the CPU 11 and the FLASH 14 is also called a controller. A sensor 30, such as a temperature sensor, is coupled to the ADC 15. For example, the outside air temperature detected with the temperature sensor is stored in the RAM 13 as the floating-point numerical data via the ADC 15. The communication circuit 16 is such as CAN, I²C, SPI, and Ethernet, and is coupled to a communication circuit of the micro controller 20. For example, the CPU 11 converts the outside air temperature of the floating-point numerical data stored in the RAM 13 into integer data, and stores the converted integer data in the RAM 13. The CPU 11 or the DTC/DMAC 12 sends out the outside air temperature of the integer data stored in the RAM 13 to the communication circuit 16, and the communication circuit 16 sends the outside air temperature of the integer data to the micro controller 20. On the contrary, the CPU 11 or the DTC/DMAC 12 store in the RAM 13 the integer data received from the micro controller 20 via the communication circuit 16. The CPU 11 converts the outside air temperature of the integer data stored in the RAM 13 into the floating-point data, and stores the converted floating-point data in the RAM 13.

In the implementation example 1, the conversion arithmetic according to the embodiment, the modified embodiment 1, or the modified embodiment 2 does not require the division and multiplication of the floating-point data. Accordingly, it is possible to reduce the processing load of the CPU. Any special circuit for the conversion arithmetic is not included. Accordingly, it is possible to suppress the increase of the circuit scale of the semiconductor device. It is also possible to improve the communication latency by compressing data through the conversion of the floating-point data to the unsigned integer data.

### Implementation Example 2

A system according to an implementation example 2 is explained with reference to FIG. 17. FIG. 17 is a block diagram illustrating the configuration of the system according to the implementation example 2.

The system 1A according to the implementation example 2 includes a micro controller 10A, a sensor 30, and a micro controller 20. The micro controller 10A includes a central processing unit (CPU) 11, a data transfer controller/direct memory access controller (DTC/DMAC) 12, a random access memory (RAM) 13, a flash memory (FLASH) 14, an analog-to-digital conversion circuit (ADC) 15, a communication circuit 16, a bus 17, and a conversion arithmetic circuit 18A. The micro controller 10A is a semiconductor device formed over one semiconductor chip (a semiconductor substrate). The conversion arithmetic according to the embodiment, the modified embodiment 1, or the modified embodiment 2 is performed by the conversion arithmetic circuit 18A.

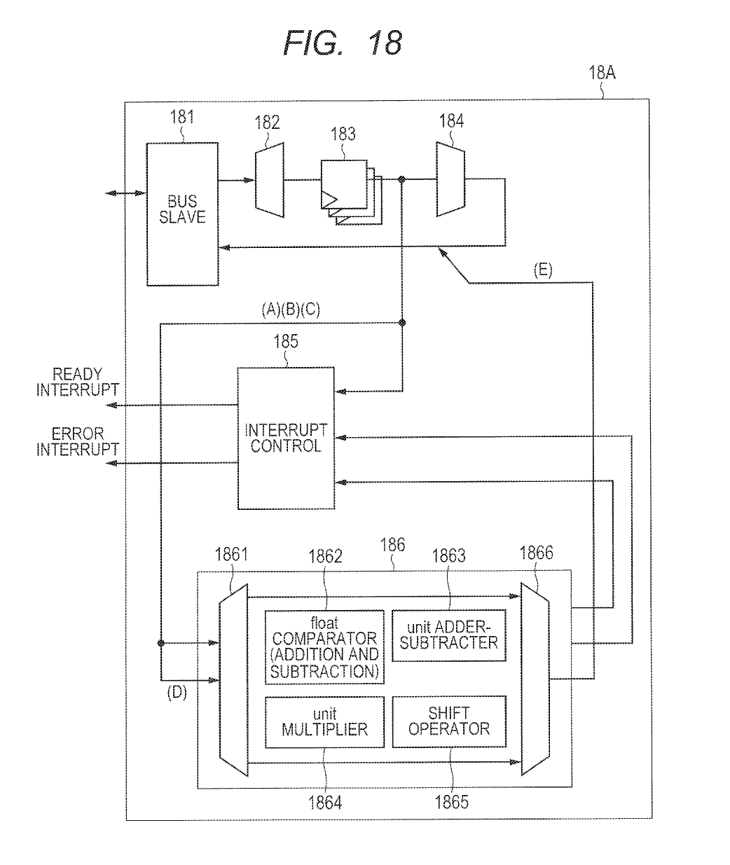

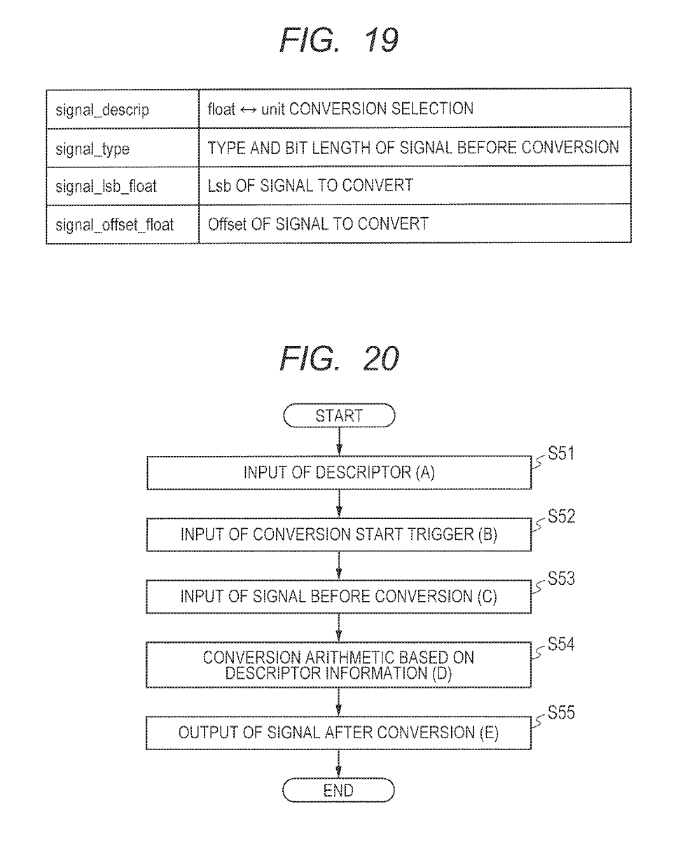

The conversion arithmetic circuit 18A is explained with reference to FIG. 18 to FIG. 20. FIG. 18 is a block diagram illustrating the configuration of the conversion arithmetic circuit according to the implementation example 2. FIG. 19 illustrates the configuration of a descriptor. FIG. 20 is a flow chart of the operation.

The conversion arithmetic circuit 18A includes a bus slave 181, a demultiplexer 182, a register 183, a multiplexer 184, an interrupt control circuit 185, and an arithmetic circuit 186. The bus slave 181 serves as an interface of access from the bus master 112 (the CPU 11 or the DTC/DMAC 12), and the descriptor to be described later is written in the register 183 via the bus slave 181 and the demultiplexer 182. The contents of the register 183 and the conversion arithmetic result of the arithmetic circuit 186 are read via the multiplexer 184 and the bus slave 181. Control information is written in the interrupt control circuit 185 via the register 183. The interrupt control circuit 185 generates a ready interrupt signal and an error interrupt signal, based on a conversion completion signal and a conversion error signal outputted from the arithmetic circuit 186. The ready interrupt signal is sent to the DTC/DMAC 12 and the error interrupt signal is sent to the CPU 11.

The arithmetic circuit 186 includes a demultiplexer 1861, a floating-point data (float) comparator (adder-subtracter) 1862, an integer data (unit) adder-subtracter 1863, an integer data (unit) multiplier 1864, a shift operator 1865, and a multiplexer 1866. The arithmetic circuit 186 performs the conversion arithmetic of the embodiment, the modified embodiment 1, and the modified embodiment 2. When performing the conversion arithmetic of any one of the embodiment, the modified embodiment 1, and the modified embodiment 2, it is not necessary to include the unnecessary arithmetic unit.

As illustrated in FIG. 19, the descriptor for executing conversion arithmetic circuit 18A includes “signal_descrip”, “signal_type”, “signal_lsb_float”, and “signal_offset_float.” “signal_descrip” specifies the conversion selection of float and unit (selection of either compression or decompression). “signal_type” specifies the type of a signal before the conversion (either floating point or integer) and the bit length. “signal_lsb_float” specifies Lsb before the conversion. “signal_offset_float” specifies Offset before the conversion.

Step S51: The bus master 112 writes the descriptor stored in the FLASH 14 into the register 183.

Step S52: The bus master 112 writes the trigger of the conversion start stored in the FLASH 14 into the register 183.

Step S53: The bus master 112 writes the signal before the conversion stored in the RAM 13 into the register 183.

Step S54: The arithmetic circuit 186 executes the conversion arithmetic based on the information of the descriptor.

Step S55: Responding to the conversion completion interrupt request, the bus master 112 reads the data that the arithmetic circuit 186 has converted, and stores the data in the RAM 13.

A sensor 30, such as a temperature sensor, is coupled to the ADC 15. For example, the outside air temperature detected with the temperature sensor is stored in the RAM 13 as the floating-point numerical data via the ADC 15. The communication circuit 16 is coupled to the communication circuit of the micro controller 20. For example, the conversion arithmetic circuit 18A converts the outside air temperature of the floating-point numerical data stored in the RAM 13 into integer data, and stores the converted integer data in the RAM 13. The DTC/DMAC 12 sends out the outside air temperature of the integer data stored in the RAM 13 to the communication circuit 16, and the communication circuit 16 sends the outside air temperature of the integer data to the micro controller 20. On the contrary, the DTC/DMAC 12 store in the RAM 13 the integer data received from the micro controller 20 via the communication circuit 16. The conversion arithmetic circuit 18A converts the outside air temperature of the integer data stored in the RAM into floating-point data, and stores the converted floating-point data in the RAM 13.

In the implementation example 2, the conversion arithmetic according to the embodiment, the modified embodiment 1, or the modified embodiment 2 does not require the divider and the multiplier of floating-point data. Accordingly, it is possible to suppress the increase of the circuit scale of the conversion arithmetic circuit. It is also possible to reduce the load of the CPU since the conversion arithmetic is included. It is also possible to improve the communication latency by compressing data through the conversion of the floating-point data to the unsigned integer data.

### Implementation Example 3

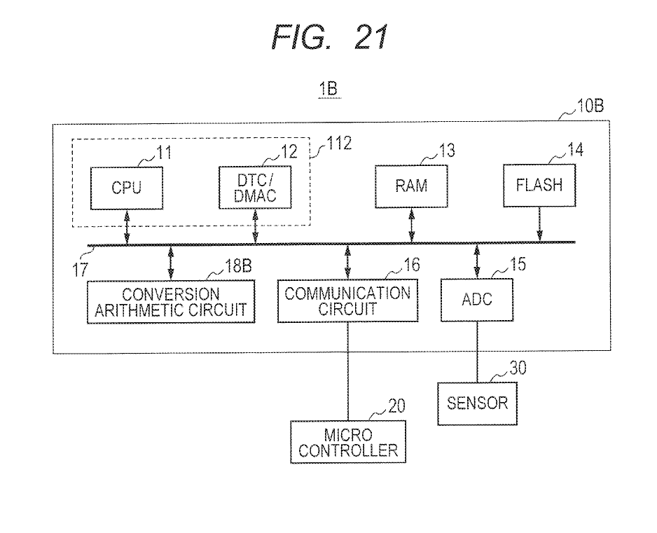

A system according to an implementation example 3 is explained with reference to FIG. 21. FIG. 21 is a block diagram illustrating the configuration of the system according to the implementation example 3.

The system 1B according to the implementation example 3 includes a micro controller 10B, a sensor 30, and a micro controller 20. The micro controller 10B includes a central processing unit (CPU) 11, a data transfer controller/direct memory access controller (DTC/DMAC) 12, a random access memory (RAM) 13, a flash memory (FLASH) 14, an analog-to-digital conversion circuit (ADC) 15, a communication circuit 16, a bus 17, and a conversion arithmetic circuit 18B. The micro controller 10B is a semiconductor device formed over one semiconductor chip (a semiconductor substrate). The conversion arithmetic according to the embodiment, the modified embodiment 1, or the modified embodiment 2 is performed by the conversion arithmetic circuit 18B.

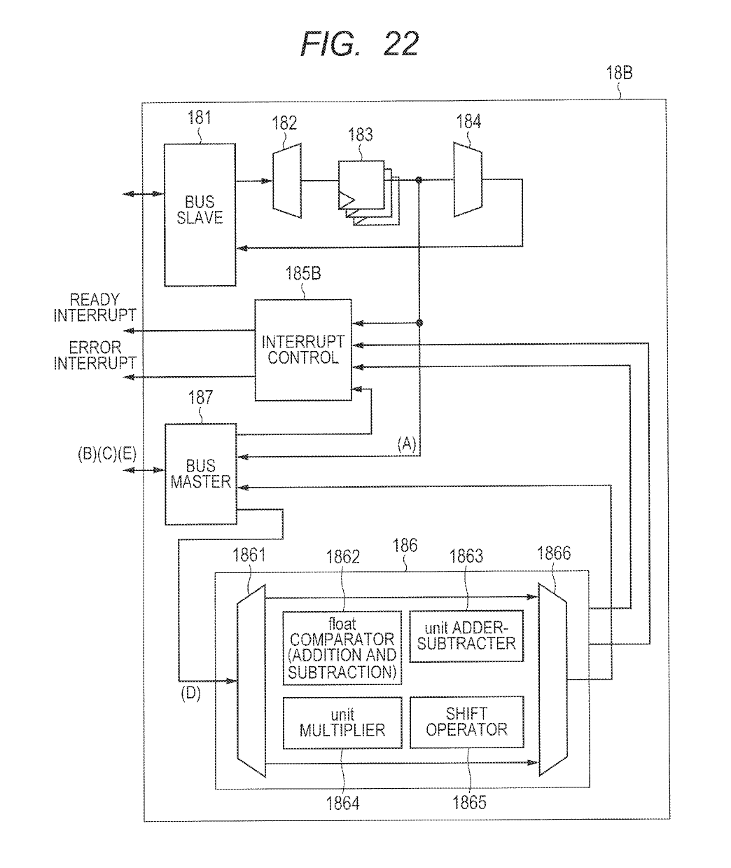

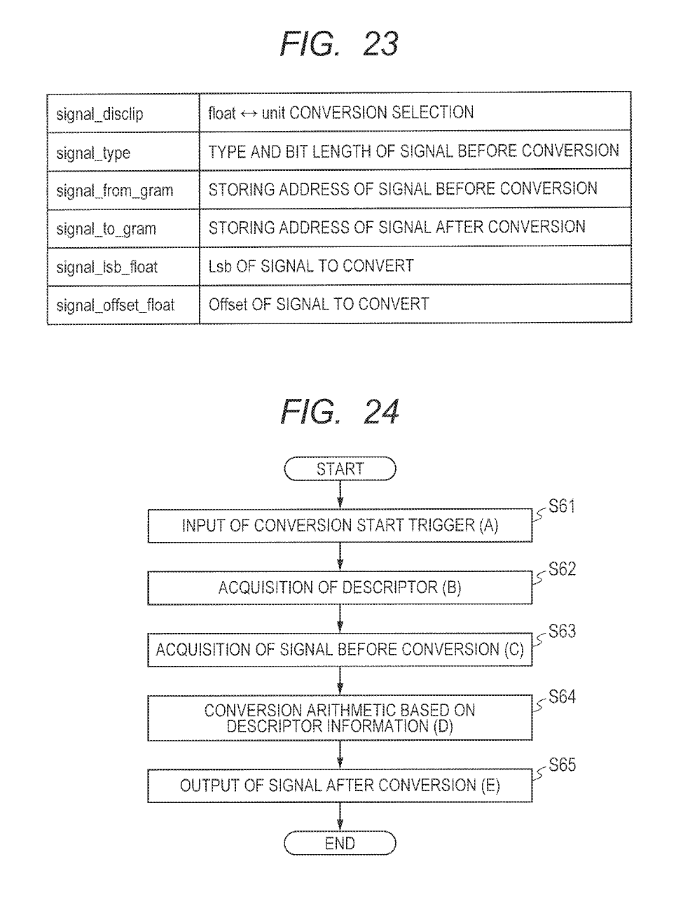

The conversion arithmetic circuit 18B is explained with reference to FIG. 22 to FIG. 24. FIG. 22 is a block diagram illustrating the configuration of the conversion arithmetic circuit according to the implementation example 3. FIG. 23 illustrates the configuration of a descriptor. FIG. 24 is a flow chart of an operation.

The conversion arithmetic circuit 18B includes a bus slave 181, a demultiplexer 182, a register 183, a multiplexer 184, an interrupt control circuit 185B, an arithmetic circuit 186, and a bus master 187. The bus slave 181 serves as an interface of access from the bus master 112 (the CPU 11 or the DTC/DMAC 12), and a trigger of the conversion start to be described later is written in the register 183 via the bus slave 181 and the demultiplexer 182. The contents of the register 183 and the conversion arithmetic result of the arithmetic circuit 186 are read via the multiplexer 184 and the bus slave 181. Control information is written in the interrupt control circuit 185B via the register 183. The interrupt control circuit 185 generates a ready interrupt signal and an error interrupt signal, based on a conversion completion signal and a conversion error signal outputted from the arithmetic circuit 186. The ready interrupt signal is sent to the DTC/DMAC 12 and the error interrupt signal is sent to the CPU 11. The arithmetic circuit 186 is the same as that of the implementation example 2.

The bus master 187 reads a descriptor from the FLASH 14, and sends the descriptor to the arithmetic circuit 186. The result of the conversion arithmetic outputted from the arithmetic circuit 186 is written in the place specified by the descriptor (such as the RAM 13 and the communication circuit 16).

As illustrated in FIG. 23, the descriptor for executing the conversion arithmetic circuit 18B includes “signal_descrip”, “signal_type”, “signal_from_gram”, “signal_to_gram”, “signal_lsb_float”, and “signal_offset_float.” “signal_descrip” specifies the conversion selection of float and unit (selection of either compression or decompression). “signal_type” specifies the type of a signal before the conversion (either floating point or integer) and the bit length. “signal_from_gram” specifies the storing address of the signal before the conversion. “signal_to_gram” specifies the storing address of the signal after the conversion. “signal_lsb_float” specifies Lsb before the conversion. “signal_offset_float” specifies Offset before the conversion.

Step S61: The bus master 112 writes the trigger of the conversion start stored in the FLASH 14 into the register 183.

Step S62: Based on the trigger of the conversion start, the bus master 187 reads the descriptor stored in the FLASH 14, and sends the descriptor to the arithmetic circuit 186.

Step S63: The bus master 187 reads the signal before the conversion stored in the place specified based on the contents of the descriptor, and sends the signal to the arithmetic circuit 186.

Step S64: The arithmetic circuit 186 executes the conversion arithmetic based on the information of the descriptor.

Step S65: The bus master 187 reads the data that the arithmetic circuit 186 has converted and stores the data in the place specified based on the information of the descriptor.

A sensor 30, such as a temperature sensor, is coupled to the ADC 15. For example, the outside air temperature detected with the temperature sensor is stored in the RAM 13 as the floating-point numerical data via the ADC 15. The communication circuit 16 is coupled to the communication circuit of the micro controller 20. For example, the conversion arithmetic circuit 18B converts the outside air temperature of the floating-point numerical data stored in the RAM 13 into integer data, and sends the converted integer data to the communication circuit 16. The communication circuit 16 sends the outside air temperature of the integer data to the micro controller 20. On the contrary, the conversion arithmetic circuit 18B reads the integer data received from the micro controller 20 via the communication circuit 16, and converts the integer data into the floating-point data and stores the converted floating-point data in the RAM 13.

In implementation example 3, the conversion arithmetic according to the embodiment, the modified embodiment 1, or the modified embodiment 2 does not require the divider and the multiplier of floating-point data. Accordingly, it is possible to suppress the increase of the circuit scale of the conversion arithmetic circuit. The bus master is included in the conversion arithmetic circuit; accordingly, it is possible to reduce the load of the bus master such as the CPU and the DTC/DAMC. It is also possible to improve the communication latency by compressing data through the conversion of the floating-point data to the unsigned integer data.

In the above, the invention made by the present inventors has been explained in detail based on the embodiment, the modified embodiments, and the implementation examples. However, it cannot be overemphasized that the present invention is not restricted to the embodiment, the modified embodiments, and the implementation examples, and it can be modified variously.

For example, the floating-point data of the single precision storage format has been explained; however, the invention is applicable also to the floating-point data of the double precision storage format.

In the implementation example 3, the conversion arithmetic circuit 18B has been explained about the example for performing the data exchange with the communication circuit 16 via the bus 17. However, the conversion arithmetic circuit 18B may perform the data exchange with the communication circuit 16 directly without passing the bus 17.

What is claimed is:

1. A semiconductor device comprising:
a memory;
a bus coupled to the memory;
a bus master coupled to the bus; and
a conversion arithmetic circuit coupled to the bus,
wherein the conversion arithmetic circuit comprises:
an adder-subtracter of floating-point data;
an adder-subtracter of integer data; and
a shift operator, and
wherein the conversion arithmetic circuit converts floating-point data to integer data or converts integer data to floating-point data, without using a multiplier and a divider of the floating-point data.

2. The semiconductor device according to claim 1,
wherein the conversion arithmetic circuit converts floating-point data supplied from a memory by the bus master to integer data, based on instructions for the conversion supplied from the bus master, and
wherein the bus master stores in the memory the result of the conversion performed by the conversion arithmetic circuit.

3. The semiconductor device according to claim 2 further comprising:
a communication circuit,
wherein the bus master supplies the result of the conversion stored in the memory to the communication circuit.

4. The semiconductor device according to claim 1,
wherein the conversion arithmetic circuit reads floating-point data from the memory and converts the read floating-point data to integer data, based on the instructions supplied from the bus master.

5. The semiconductor device according to claim 4 further comprising:
a communication circuit,
wherein the conversion arithmetic circuit supplies the result of the conversion to the communication circuit.

6. The semiconductor device according to claim 1,
wherein the conversion arithmetic circuit converts floating-point data to integer data employing a bisection method that iterates comparison with a middle value.

7. The semiconductor device according to claim 6,
wherein the conversion arithmetic circuit performs the conversion by obtaining the middle value from a maximum value and a minimum value that the floating-point data can take.

8. The semiconductor device according to claim 6,
wherein the bit length of the integer data is assumed to be n, the range that the floating-point data can take is assumed to be Range, the minimum value that the floating-point data can take is assumed to be Offset, and Range/2n is assumed to be Lsb, and
wherein the conversion arithmetic circuit performs the conversion by use of Lsb and Offset.

9. The semiconductor device according to claim 1,
wherein the conversion arithmetic circuit converts integer data to floating-point data employing an arithmetic method that iterates addition of a middle value.

10. The semiconductor device according to claim 1,
wherein the conversion arithmetic circuit further comprises:
a multiplier of integer data,
wherein the bit length of the integer data is assumed to be n, the range that the floating-point data can take is assumed to be Range, and Range/2n is assumed to be Lsb, and
wherein the conversion arithmetic circuit converts integer data to floating-point data by use of Lsb.

11. A semiconductor device comprising:
a controller including a CPU and a memory to store a program,
wherein the controller comprises:
(a) means that converts floating-point data to integer data employing a bisection method that iterates comparison with a middle value.

12. The semiconductor device according to claim 11,
wherein the (a) means performs the conversion by obtaining the middle value from a maximum value and a minimum value that the floating-point data can take.

13. The semiconductor device according to claim 12,
wherein the (a) means comprises:
(a1) a first storage means;
(a2) a second storage means;
(a3) a third storage means;
(a4) a fourth storage means;
(a5) a means to store in the first storage means the maximum value that the floating-point data as a conversion target can take;
(a6) a means to store in the second storage means the minimum value that the floating-point data of the conversion target can take;
(a7) a means to calculate a middle value of the value stored in the first storage means and the value stored in the second storage means, and to store the calculated middle value in the third storage means;
(a8) a means to set the highest-order bit of the integer data stored in the fourth storage means to “1” when the value of the floating-point data of the conversion target is larger than the middle value stored in the third storage means by the (a7) means, and to store the middle value stored in the third storage means to the second storage means; and
(a9) a means to set the highest-order bit of the integer data stored in the fourth storage means is set to “0” when the floating-point data of the conversion target is smaller than the middle value stored in the third storage means, and to store the middle value stored in the third storage means to the first storage means.

14. The semiconductor device according to claim 11,
wherein the bit length of the integer data is assumed to be n, the range that the floating-point data can take is assumed to be Range, the minimum value that the floating-point data can take is assumed to be Offset, and Range/2n is assumed to be Lsb, and
wherein the (a) means performs the conversion by use of Lsb and Offset.

15. The semiconductor device according to claim 14,
wherein the (a) means comprises:
(a21) a 21st storage means;
(a22) a 22nd storage means;
(a23) a 23rd storage means;
(a24) a means to subtract Offset from floating-point data of a conversion target and to store the subtracted result in the 21st storage means;
(a25) a means to store Range in the 22nd storage means;
(a26) a means to divide the value stored in the 22nd storage means by 2 and to store the divided result in the 22nd storage means;
(a27) a means to set to “1” the highest-order bit of the integer data stored in the 23rd storage means when the value stored in the 22nd storage means is not greater than the value stored in the 21st storage means; and
(a28) a means to set to “0” the highest-order bit of the integer data stored in the 23rd storage means when the value stored in the 22nd storage means is larger than the value stored in the 21st storage means.

16. The semiconductor device according to claim 15, wherein the (a27) means sets the highest-order bit of the integer data stored in the 23rd storage means to “1” and sets the other bits to “0” when the value stored in the 22nd storage means is equal to the value stored in the 21st storage means.

17. The semiconductor device according to claim 11,
wherein the controller comprises:
(b) a means to convert integer data to floating-point data employing an arithmetic method that iterates addition of the middle value.

18. The semiconductor device according to claim 17,
wherein the (b) means comprises:
(b1) a 31st storage means;
(b2) a 32nd storage means;
(b3) a 33rd storage means;
(b4) a 34th storage means;
(b5) a means to store in the 31st storage means the maximum value that the floating-point data can take;
(b6) a means to store in the 32nd storage means the minimum value that the floating-point data can take;
(b7) a means to calculate a middle value of the value stored in the 31st storage means and the value stored in the 32nd storage means, and to store the calculated middle value in the 33rd storage means;
(b8) a means to add the value of the 33rd storage means to the value of the 34th storage means and to store the added result in the 34th storage means and to store the value of the 33rd storage means in the 31st storage means when the highest-order bit of the value of the integer data of the conversion target is “1”, and
(b9) a means to store the value of the 33rd storage means in the 31st storage means when the highest-order bit of the value of the integer data of the conversion target is “0.”

19. The semiconductor device according to claim 15,
wherein the bit length of the integer data is assumed to be n, the range that the floating-point data can take is assumed to be Range, and Range/2n is assumed to be Lsb, and
wherein the controller comprises:
(c) a means to convert integer data to floating-point data by use of Lsb.

20. The semiconductor device according to claim 19,
wherein the (c) means comprises:
(c1) a means to decompose Lsb given into an exponent and a significand;
(c2) a means to convert the significand into an integer (integer significand) and to shift the exponent;
(c3) a means to multiply the integer data to the integer significand of the conversion target; and
(c4) a means to convert into a significand the value obtained by the (c3) means, and to shift the exponent shifted by the (c2) means.
